(19) United States
(12) Patent Application Publication
(10) Pub. No.: US 2008/0123087 A1
(43) Pub. Date: May 29, 2008

(54) OPTICAL LENS TESTING DEVICE

(75) Inventor: GA-LANE CHEN, Santa Clara, CA (US)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/849,109

(22) Filed: Aug. 31, 2007

(30) Foreign Application Priority Data
Nov. 27, 2006 (CN) 200610201144.9

(51) Int. Cl. G01M 11/02

(52) U.S. Cl. 356/124; 977/773

(57) ABSTRACT

An optical lens testing device (10) includes a light source (12), a resolution test chart (16), and a diffusion plate (14). The diffusion plate (14) is disposed between the light source (12) and the resolution test chart (16). The diffusion plate (14) includes a base (141) and a diffusion layer (142) formed thereon. The diffusion layer (142) has a plurality of nano-sized silicon dioxide particles (144) dispersed therein for uniformly dispersing the light beams emitted from the light source (12) so as to improve the precision and reliability of the optical lens testing device (10).

### BACKGROUND

1. Technical Field

The invention relates to optical testing devices, and particularly to a testing device for testing the resolving power of optical lenses.

2. Description of Related Art

In recent years, image pickup apparatuses have become widely used in a variety of portable electronic devices, such as mobile phones, notebook computers and personal digital assistants (PDAs). A typical image pickup apparatus of the related art includes an optical lens, which is an essential element for forming an image as light from an image object passes through the optical lens and is received in the image pickup apparatus. An image of object can then be formed.

However, as technology has improved the demand for the increased image quality has correspondingly increased. As the optical lens is critical to the image quality of the image pickup apparatus, the optical lens fabrication process generally includes testing steps for testing performance of the optical lens, such as resolving power, image clarity etc. Therefore, a testing device is needed for testing the optical lens.

Referring to FIG. 1, a conventional optical lens testing device 30 includes a light source 301 and a resolution test chart 302. An optical lens module 32, which includes an optical lens 321 to be tested and an image pickup device 322, is disposed opposite to the optical lens testing device 30. The light source 301 emits light which passes through the resolution test chart 302 and the optical lens 321, and finally reaches the image pickup device 322. Thus, an image of the resolution test chart 302 is obtained by the image pickup device 322. However, the light emitted by the light source 301 may have a non-uniform distribution, and the test results obtained by the conventional optical lens testing device 30 may therefore be rendered unreliable.

What is needed, therefore, is an optical lens testing device having improved precision and more reliable test results.

### SUMMARY

An optical lens testing device is provided. In one embodiment, the optical lens testing device includes a light source, a resolution test chart, and a diffusion plate. The diffusion plate is disposed between the light source and the resolution test chart. The diffusion plate includes a base and a diffusion layer formed thereon. The diffusion layer has a plurality of nano-sized silicon dioxide particles dispersed therein.

Advantages and novel features of the present optical lens testing device will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a schematic view of a conventional optical lens testing device for testing an optical lens module; and

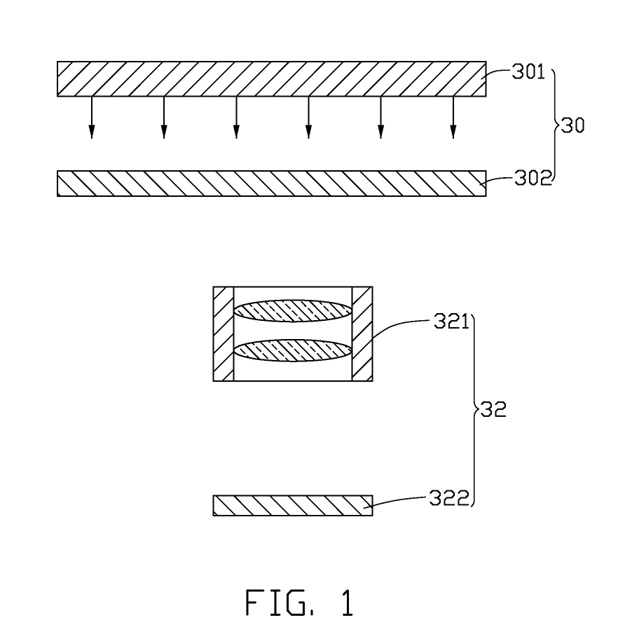

FIG. 2 is a schematic view of an optical lens testing device in accordance with a preferred embodiment of the present invention.

Corresponding reference characters indicate corresponding parts throughout the drawings. The exemplifications set out herein illustrate at least one preferred embodiment of the present optical lens testing device, in one form, and such exemplifications are not to be construed as limiting the scope of the invention in any manner.

### DETAILED DESCRIPTION OF THE EMBODIMENT

Reference will now be made to the drawings to describe embodiments of the present optical lens testing device in detail.

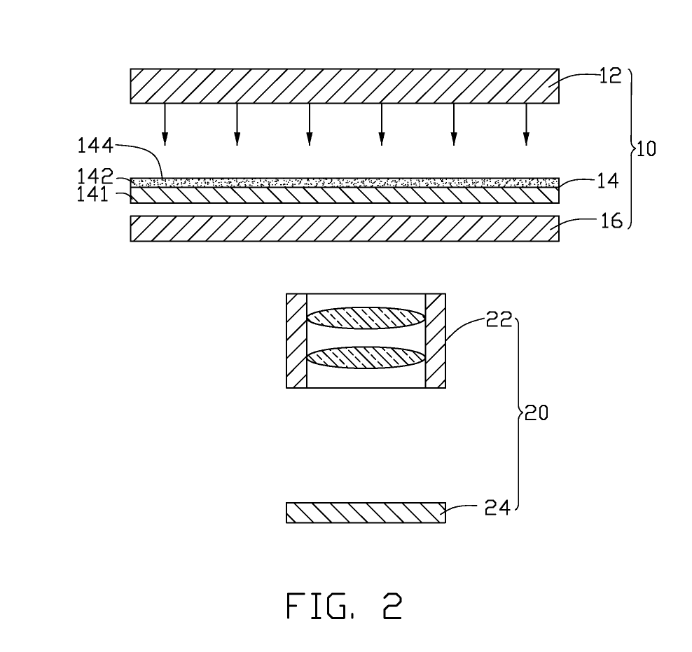

Referring to FIG. 2, an optical lens testing device 10 according to a preferred embodiment of the present invention is shown. The optical lens testing device 10 includes a light source 12, a diffusion plate 14, and a resolution test chart 16. The diffusion plate 14 is disposed between the light source 12 and the resolution test chart 16. As is shown in FIG. 2, an optical lens module 20 including an optical lens 22 to be tested and an image pickup device 24 is disposed opposite to the optical lens testing device 10. The light source 12 emits light which passes through the diffusion plate 14, the resolution test chart 16, the optical lens 22 and finally reaches the image pickup device 24.

In the present embodiment, the light source 12 can be a cold cathode fluorescent lamp (CCFL) or a light emitting diode (LED) array.

The diffusion plate 14 includes a base 141 and a diffusion layer 142. The diffusion layer 142 is formed on the base 141 and faces towards the light source 12. In the present embodiment, the base 141 can be made of optical grade plastic, such as polymethylmethacrylate (PMMA) or polycarbonate (PC). Preferably, the base 141 in the present embodiment should be made of polymethylmethacrylate (PMMA) with a light transmittance equal to or greater than about 90%.

The diffusion layer 142 comprises a matrix material and nano-sized silicon dioxide (SiO₂) particles 144 dispersed therein. The matrix material can be PMMA or PC. Advantageously, a percentage by mass of the nano-sized silicon dioxide particles 144 in the diffusion layer 142 can be in an approximate range from 2% to 30%. More preferably, the percentage by mass of the nano-sized silicon dioxide particles 144 should be in an approximate range from 5% to 20%. In addition, a thickness of the diffusion layer 142 can be in an approximate range from 200 nm to 20000 nm. Preferably, the diffusion layer 142 should have a thickness of about 500 nm to 2000 nm.

In the present embodiment, a diameter of the nano-sized silicon dioxide particle 144 can be in an approximate range from 10 nm to 200 nm. Additionally, the nano-sized silicon dioxide particles 144 can be distributed uniformly in the diffusion layer 142. Alternatively, the nano-sized silicon dioxide particles 144 can be dispersed in areas of the diffusion layer 142 where the light emitted by the light source 12 is allowed to pass through. Hence, the light beams emitted by the light source 12 are spread so as to be emitted essentially uniformly from the diffusion plate 14.

In the present embodiment, the image pickup device 24 can be a charge coupled device (CCD) or a complementary metal-oxide semiconductor (CMOS). Generally, the image pickup device 24 can be coupled to a data processor. Moreover, in order to obtain a clear image, the optical lens module 20 can move in one direction perpendicular to the resolution test chart 16.

When the light emitted by the light source 12 passes the diffusion plate 14, the nano-sized silicon dioxide particles 144 in the diffusion layer 142 are used to diffuse the light beams. Consequentially, the light emitted from the diffusion plate 14 is spread essentially uniformly across the light diffusion plate 14. In the testing steps, the optical lens 22 to be tested is positioned between the resolution test chart 16 and the image pickup device 24. Therefore, the diffused light can pass through the resolution test chart 16 and the optical lens 22 in succession so that the image of the resolution test chart 16 can be captured by the image pickup device 24. By way of disposing the diffusion plate 14 containing nano-sized silicon dioxide particles 144 in the optical lens testing device 10 to distribute the light emitted by the light source 12 essentially uniformly over the diffusion plate 14, the precision and reliability of the test results for the optical lens 22 is thus improved.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. An optical lens testing device, comprising:
a light source;
a resolution test chart; and
a diffusion plate disposed between the light source and the resolution test chart, the diffusion plate comprising a base and a diffusion layer formed thereon, the diffusion layer having a plurality of nano-sized silicon dioxide particles dispersed therein.

2. The optical lens testing device as claimed in claim 1, wherein the nano-sized silicon dioxide particles are uniformly distributed in the diffusion layer.

3. The optical lens testing device as claimed in claim 1, wherein the diffusion layer faces towards the light source.

4. The optical lens testing device as claimed in claim 1, wherein the base has a light transmittance equal to or greater than about 90%.

5. The optical lens testing device as claimed in claim 1, wherein the base comprises polymethylmethacrylate or polycarbonate.

6. The optical lens testing device as claimed in claim 1, wherein the diffusion layer comprises a mixture of the nano-sized silicon dioxide particles and polymethyl methacrylate or a mixture of the nano-sized silicon dioxide particles and polycarbonate.

7. The optical lens testing device as claimed in claim 6, wherein a percentage by mass of the nano-sized silicon dioxide particles in the diffusion layer is in an approximate range from 2% to 30%.

8. The optical lens testing device as claimed in claim 1, wherein a thickness of the diffusion layer is in an approximate range from 200 nm to 20000 nm.

9. The optical lens testing device as claimed in claim 1, wherein a thickness of the diffusion layer is in an approximate range from 500 nm to 2000 nm.

10. The optical lens testing device as claimed in claim 1, wherein a diameter of the nano-sized silicon dioxide particle is in an approximate range from 10 nm to 200 nm.
